(19) United States
(12) Patent Application Publication
(10) Pub. No.: US 2026/0211195 A1
(43) Pub. Date: Jul. 23, 2026

(54) PHOTONIC SEMICONDUCTOR PACKAGES AND METHOD OF FORMING THE SAME

(71) Applicant: Taiwan Semiconductor Manufacturing Co., Ltd., Hsinchu (TW)

(72) Inventors: Ming-Fa Chen, Taichung City (TW); Yu-Siang Lin, Hsinchu (TW)

(21) Appl. No.: 19/270,763

(22) Filed: Jul. 16, 2025

Related U.S. Application Data
(60) Provisional application No. 63/748,727, filed on Jan. 23, 2025.

(51) Int. Cl. G02B 6/42

(52) U.S. Cl. CPC G02B 6/4215

(57) ABSTRACT

A device includes a photonic layer that includes a waveguide and a grating coupler, wherein the waveguide is optically coupled to the grating coupler; an interconnect structure over the photonic layer; an electronic die bonded to the interconnect structure; and a support over the electronic die, wherein the support includes a metalens, wherein the metalens is optically coupled to the grating coupler.

### PRIORITY CLAIM AND CROSS-REFERENCE

This application claims the benefit of U.S. Provisional Application No. 63/748,727, filed on Jan. 23, 2025, which application is hereby incorporated herein by reference.

### BACKGROUND

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) components and electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1, 2, 3, 4, and 5 illustrate intermediate steps in the formation of an optical engine, in accordance with some embodiments.

FIGS. 6 and 7 illustrate intermediate steps in the formation of a metalens of an optical engine, in accordance with some embodiments.

FIGS. 8A and 8B illustrate perspective views of metalenses, in accordance with some embodiments.

FIGS. 9 and 10 illustrate intermediate steps in the formation of an optical engine, in accordance with some embodiments.

FIG. 11 illustrates a cross-sectional view of an optical engine, in accordance with some embodiments.

FIG. 12 illustrates a schematic view of metalenses configured to transmit focused signals into an optical fiber, in accordance with some embodiments

FIG. 13 illustrates a perspective-view schematic of metalenses configured to transmit focused signals into a fiber array, in accordance with some embodiments.

FIG. 14 illustrates a perspective-view schematic of metalenses configured to transmit focused signals into a single optical fiber, in accordance with some embodiments.

FIG. 15 illustrates a cross-sectional view of an optical engine, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Various structures such as packages comprising photonic structures or the like and their methods of formation are described herein. In some embodiments, an optical engine includes one or more metalenses that allow for the manipulation of light beams. For example, the metalenses can be configured to receive optical signals from a grating coupler and focus the optical signals into one or more optical fibers. The meta-atoms of the metalenses can be flexibly configured to provide desired control of light beams, allowing for greater degrees of freedom in device design. In this manner, the metalenses as described herein can facilitate efficient optical communication by a photonic semiconductor package or the like.

Embodiments discussed herein are to provide examples to enable making or using the subject matter of this disclosure, and a person having ordinary skill in the art will readily understand modifications that can be made while remaining within contemplated scopes of different embodiments. Throughout the various views and illustrative embodiments, like reference numbers are used to designate like elements. Although method embodiments may be discussed as being performed in a particular order, other method embodiments may be performed in any logical order.

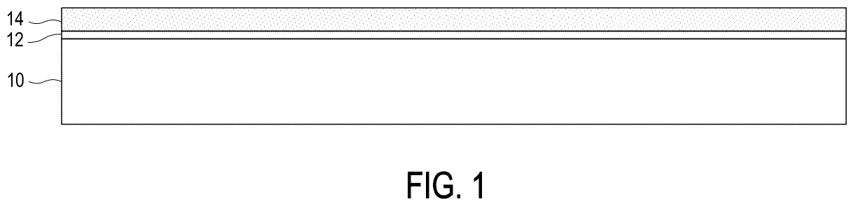

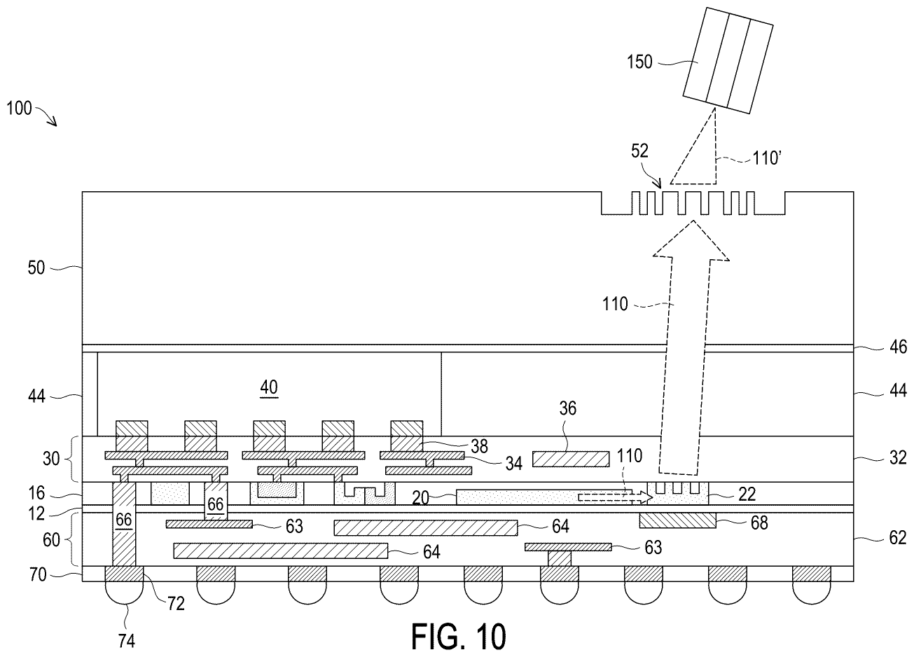

FIGS. 1 through 10 illustrate intermediate steps in the formation of an optical engine 100 (see FIG. 10), in accordance with some embodiments. The optical engine 100 comprises waveguides, photonic components, and integrated circuits that may be configured to receive, generate, modify, transmit, and/or process optical signals. In some embodiments, the optical engine 100 provides an input/output (I/O) interface between optical signals and electrical signals in a package or package component. In some embodiments, the optical engine 100 provides an optical network for signal communication between various components (e.g., photonic devices, integrated circuits, couplings to external fibers, etc.). In this manner, the optical engine 100 can enable optical-electrical (OE) conversion for package-level optical communication (e.g., within a package) and/or for optical communication with external components (e.g., via optical fiber(s)). In some cases, the optical engine 100 may be considered a photonic package component, an optical package module, a silicon photonic chip, a photonic die, a photonic semiconductor package, or the like.

Turning to FIG. 1, the optical engine 100 comprises at this stage a substrate 10, a dielectric layer 12, and photonic material 14, in accordance with some embodiments. In an embodiment, at a beginning of the manufacturing process of the optical engine 100, the substrate 10, the dielectric layer 12, and the photonic material 14 may collectively be part of a silicon-on-insulator (SOI) substrate or the like, which may be doped (e.g., with a p-type or an n-type dopant) or undoped. In some embodiments, the substrate 10 may be a wafer, such as a silicon wafer. Other substrates, such as a silicon-on-insulator (SOI) substrate, a multi-layered substrate, or a gradient substrate may also be used. In some embodiments, the semiconductor material of the substrate 10 may include silicon; germanium; a compound semiconductor including silicon carbide, gallium arsenide, gallium phosphide, indium phosphide, indium arsenide, and/or indium antimonide; an alloy semiconductor including silicon-germanium, gallium arsenide phosphide, aluminum indium arsenide, aluminum gallium arsenide, gallium indium arsenide, gallium indium phosphide, and/or gallium indium arsenide phosphide; or combinations thereof. In other embodiments, the substrate 10 may be a dielectric material such as silicon oxide, glass, ceramic, plastic, or any other suitable material that allows for structural support of overlying devices. Other substrates, such as a multi-layered or gradient substrate, may also be used. The substrate 10 may be free of passive or active devices, in some cases. In some embodiments, multiple optical engines 100 are formed on a single substrate 10 and then are subsequently singulated into individual optical engines 100.

The dielectric layer 12 may be a dielectric layer that separates the substrate 10 from the overlying photonic material 14. In some embodiments, the dielectric layer can also serve as a portion of cladding material that surrounds the subsequently manufactured photonic components (described below). In an embodiment, the dielectric layer 12 may be silicon oxide, silicon nitride, germanium oxide, germanium nitride, the like, or a combination thereof. The dielectric layer 12 may be formed using a technique such as implantation (e.g., to form a buried oxide (BOX) layer) or using a suitable deposition technique such as chemical vapor deposition (CVD), atomic layer deposition (ALD), physical vapor deposition (PVD), combinations of these, or the like. However, any suitable material and method of manufacture may be used.

The photonic material 14 is formed over the dielectric layer 12. In some embodiments, the photonic material 14 may be a semiconductor material such as silicon, germanium, silicon germanium, a III-V semiconductor material, a compound semiconductor material, the like, or a combination thereof. In other embodiments, the photonic material 14 may comprise a dielectric material such as silicon nitride or the like, lithium niobate materials, polymers, the like, or a combination thereof. The photonic material 14 may be formed using a suitable technique, such as epitaxial growth, CVD, ALD, PVD, the like, or combinations thereof. Other materials or techniques are possible. In some cases, the photonic material 14 may be considered an “active layer” or the like.

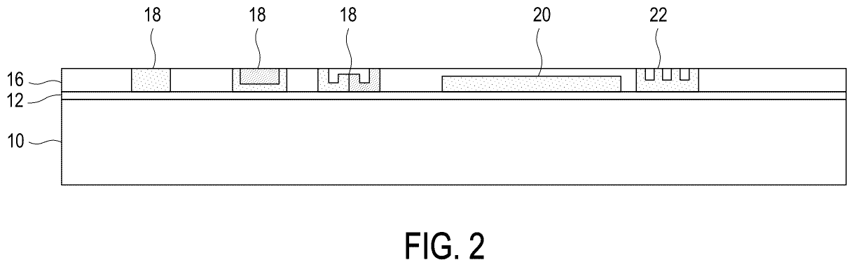

FIG. 2 illustrates the formation of photonic components 18 from the photonic material 14, in accordance with some embodiments. In some embodiments, the photonic components 18 may include such devices or components as optical waveguides 20 (e.g., ridge waveguides, rib waveguides, buried channel waveguides, diffused waveguides, etc.), grating couplers 22, other couplers (e.g., edge couplers, evanescent couplers, etc.), directional couplers, optical modulators (e.g., germanium modulators, Mach-Zehnder silicon-photonic switches, microelectromechanical switches, micro-ring resonators, etc.), amplifiers, multiplexors, demultiplexors, optical-to-electrical converters (e.g., photodetectors, P-N junctions, or the like), electrical-to-optical converters, lasers (e.g., laser diodes), phase shifters, combinations of these, or the like. However, the photonic components 18 may comprise other devices, structures, or components than these examples. FIG. 2 illustrates various photonic components 18 including a waveguide 20 and a grating coupler 22 that are separately indicated. Other numbers, arrangements, configurations, or types of photonic components 18 are possible.

The photonic components 18 of FIG. 2 includes one or more waveguides 20 and one or more grating couplers 22. In some embodiments, the waveguide 20 is a silicon waveguide, though other waveguides are possible. A waveguide 20 may be optically coupled to other waveguide(s) 20, grating coupler(s) 22, or photonic component(s) 18. For example, a waveguide 20 may be optically coupled to an adjacent grating coupler 22, such that optical signals may be transmitted between the waveguide 20 and the grating coupler 22. In some cases, a waveguide 20 and a grating coupler 22 may be portions of a continuous structure formed from the photonic material 14.

In some embodiments, the photonic components 18 may be formed by patterning the photonic material 14 into the appropriate shapes for the photonic components 18. For example, photonic material 14 may be patterned using one or more photolithographic masking and etching processes, though any suitable methods of patterning the photonic material 14 may be utilized. The patterning may expose portions of the dielectric layer 12. In some cases, additional processing steps may be performed to form some types of photonic components 18, such as additional implantation processes, deposition processes, epitaxial growth processes, and/or patterning processes. In some embodiments, one or more photonic components 18 may be formed by patterning the photonic material 14 and then depositing another material on portions of the patterned photonic material 14. For example, the formation of a photonic component 18 may comprise patterning a photonic material 14 comprising silicon and then epitaxially growing a region of germanium on the patterned photonic material 14. Other materials, techniques, or process steps are possible.

Still referring to FIG. 2, a dielectric layer 16 may be formed over the dielectric layer 12 and/or the photonic components 18, in accordance with some embodiments. The dielectric layer 16 may be, for example, a dielectric material that separates the individual photonic components 18 from each other and from the overlying structures. Further, in some cases, the dielectric layer 16 can serve as a cladding material that at least partially surrounds and/or covers one or more photonic components 18. In some embodiments, the dielectric layer 16 may comprise silicon oxide, silicon nitride, germanium oxide, germanium nitride, combinations of these, or the like, which may be formed using suitable deposition techniques such as CVD, ALD, PVD, or the like. Other materials or deposition techniques are possible. In some embodiments, after depositing the dielectric layer 16, a planarization process (e.g., a chemical mechanical polishing (CMP) process, a grinding process, or the like) may be performed to planarize a top surface of the dielectric layer 16. In some embodiments, the planarization process may expose a top surface of one or more photonic components 18. In such embodiments, top surfaces of some photonic components 18 and top surfaces of the dielectric layer 16 may be level or coplanar (within process variations). In some embodiments, one or more photonic components 18 remain covered by the dielectric layer 16 after performing the planarization process. In some cases, the photonic components 18 and the dielectric layer 16 may collectively be considered a “photonic layer,” an “optical layer,” or the like.

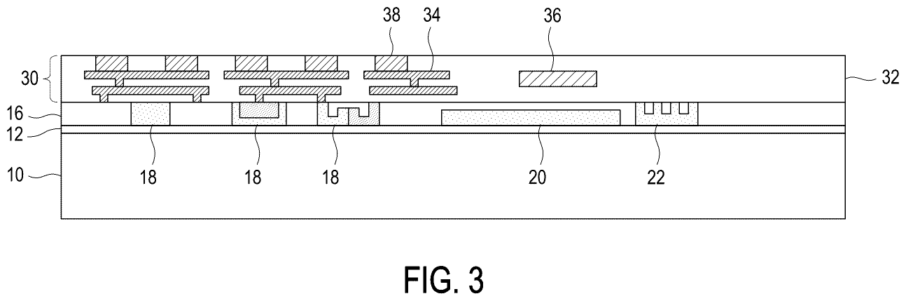

FIG. 3 illustrates the formation of an interconnect structure 30 over the dielectric layer 16, in accordance with some embodiments. The interconnect structure 30 includes dielectric layers 32 (not individually illustrated) with conductive features 34 formed in the dielectric layers 32, in some embodiments. The conductive features 34 allow for electrical communication within the optical engine 100. The conductive features 34 may comprise conductive lines, conductive vias, conductive pads, metallization patterns, redistribution layers, or the like that provide electrical interconnections and electrical routing within the optical engine 100. Some conductive features 34 may be electrically connected to one or more photonic components, in some cases. The interconnect structure 30 may also comprise conductive pads 38 at a top surface of the interconnect structure 30, in some embodiments. The conductive pads 38 may be metal pads, bonding pads, or the like.

In some embodiments, the interconnect structure 30 is formed of alternating layers of dielectric material (e.g., dielectric layers 32) and conductive material (e.g., conductive features 34). The conductive features 34 may be formed using any suitable processes such as deposition, damascene, dual damascene, or the like. In particular embodiments, the interconnect structure 30 may have multiple layers of conductive features 34, but the precise number of layers of conductive features 34 may be dependent upon the design of the optical engine 100. The dielectric layers 32 may be, for example, insulating layers and/or passivating layers, and may comprise silicon oxide, silicon nitride, a polymer, a molding material, the like, or a combination thereof. The conductive features 34 may include, for example, a metal or a metal alloy such as copper, silver, gold, tungsten, cobalt, ruthenium, aluminum, alloys thereof, combinations thereof, or the like. Other materials or formation techniques are possible.

In some embodiments, the conductive pads 38 are formed in the topmost dielectric layer 32 (not separately illustrated) of the dielectric layers 32. In some embodiments, the conductive pads 38 may include via portions (not separately illustrated) that physically and electrically contact underlying conductive features 34. In some embodiments, the topmost dielectric layer 32 of the interconnect structure 30 may be a material suitable for dielectric-to-dielectric bonding, such as silicon oxide, silicon nitride, silicon oxynitride, or the like. Other materials are possible. In some embodiments, the conductive pads 38 may be formed by first forming openings (not separately illustrated) in the topmost dielectric layer 32 that expose conductive portions of some underlying conductive features 34, depositing an optional liner in the openings, and then depositing a conductive material in the openings. The conductive material may be similar to those described for the conductive features 34. For example, the conductive material may be copper or a copper alloy, in some embodiments. A planarization process (e.g., a CMP process or a grinding process) may be performed to remove excess conductive material such that top surfaces of the conductive pads 38 and the topmost dielectric layer 32 are approximately level. This is an example, and the conductive pads 38 may be formed using other materials, techniques, or process steps.

Additionally, during the manufacture of the interconnect structure 30, one or more photonic components 36 may be formed within the dielectric layers 32, in accordance with some embodiments. The photonic components 36 may be similar to the photonic components 18 described previously. For example, in some embodiments, the photonic components 36 may include waveguides (e.g., silicon nitride waveguides), couplers, or the like. In some cases, one or more photonic components 36 may be optically coupled to each other and/or to one or more photonic components 18 or waveguides 20. In this manner, the photonic components 18, the waveguides 20, and the photonic components 36 may provide optical communication and optical interconnection within the optical engine 100.

In some embodiments, photonic components 36 may be formed during the manufacture of the interconnect structure 30 by depositing a material for photonic components 36 on a dielectric layer 32. The material for the photonic components 36 may be a dielectric material such as silicon nitride, silicon oxide, silicon oxynitride, polymer, combinations of these, or the like, or a semiconductor material such as silicon, germanium, or the like. The material may then be patterned into suitable shapes for the photonic components 36 using suitable photolithography and etching techniques. Another dielectric layer 32 may then be deposited on the photonic components 36. In particular embodiments, the interconnect structure 30 may have multiple layers of photonic components 36, but the precise number of layers of photonic components 36 may be dependent upon the design of the optical engine 100. In some cases, the interconnect structure 30, the dielectric layer 16, and the photonic components 18 (including the waveguides 20 and the grating couplers 22) may collectively be considered a photonic die, a photonic integrated circuit (PIC), a photonic interconnect structure, or the like.

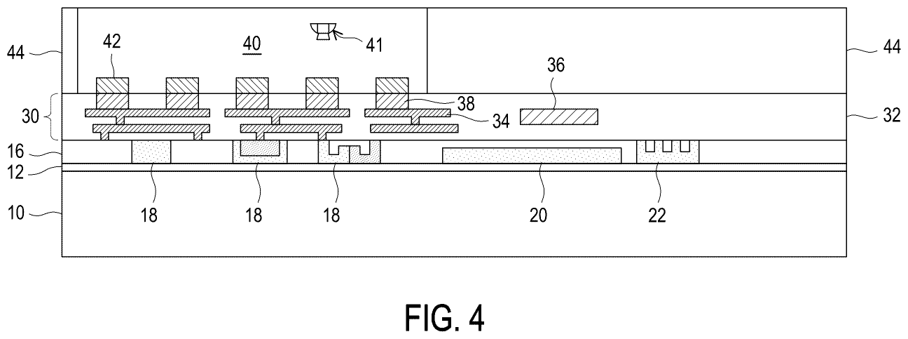

In FIG. 4, an electronic die 40 is bonded to the interconnect structure 30, in accordance with some embodiments. The electronic die 40 may be, for example, a semiconductor device, die, or chip that may comprise integrated circuits and may interact with the photonic components 18 using electrical signals. For example, the electronic die 40 may include controllers, drivers, transimpedance amplifiers, transistors, other active devices, resistors, capacitors, other passive devices, the like, or combinations thereof. Accordingly, the electronic die 40 may be considered an electronic integrated circuit (EIC) structure or the like. As a representative example, FIG. 4 illustrates a transistor 41, which may be formed at a surface of a substrate (not separately illustrated) of the electronic die 40, such as at the active surface of a semiconductor substrate. The transistor 41 may include, for example, a gate structure (e.g., a gate stack) over one or more channel regions. In some cases, the channel region(s) may include nanostructures, nanosheets, or the like. Source/drain regions may be formed adjacent the channel region(s). Source/drain region(s) may refer to a source or a drain, individually or collectively dependent upon the context. Contact plugs may be formed that couple the gate structures and/or source/drain regions, and conductive features may form connections to the contact plugs of the transistor 41 as part of an integrated circuit or the like. The transistor 41 may be, for example, a Metal Oxide Semiconductor Field-Effect Transistor (MOSFET), a planar transistor, a Fin Field-Effect Transistor (FinFET), a nanostructure Field-Effect Transistor (e.g., a nanostructure FET, nano-FET, Gate All-Around (GAA) transistor, or the like), Complementary Field-Effect Transistor (CFET), or another type of transistor. Other transistors, devices, or integrated circuits, or combinations thereof are possible within an electronic die 40. In some embodiments, the integrated circuits may be configured to interface with the photonic components 18. For example, the electronic die 40 may process electrical signals received from photonic components 18, may control the operation of the photonic components 18, and/or may generate electrical signals that photonic components 18 convert into optical signals. One electronic die 40 is shown in FIG. 4, but an optical engine 100 may include two or more electronic dies 40 in other embodiments.

In some embodiments, the electronic die 40 may provide Serializer/Deserializer (SerDes) functionality. In this manner, the electronic die 40 may act as part of an I/O interface between optical signals and electrical signals within the optical engine 100 or within a package or package component comprising the optical engine 100. In some embodiments, an electronic die 40 may comprise one or more processing devices, such as a Central Processing Unit (CPU or “xPU”), a Graphics Processing Unit (GPU), an Application-Specific Integrated Circuit (ASIC), a High-Performance Computing (HPC) die, a logic die, the like, or a combination thereof. An electronic die 40 may include one or more memory devices, which may be a volatile memory such as Dynamic Random-Access Memory (DRAM), Static Random-Access Memory (SRAM), High-Bandwidth Memory (HBM), another type of memory, or the like. Other electronic dies 40 or configurations thereof are possible.

In some embodiments, the electronic die 40 may include bond pads 42 formed in a bonding layer (not separately illustrated), and the electronic die 40 is bonded to the interconnect structure 30 by dielectric-to-dielectric bonding and/or metal-to-metal bonding (e.g., direct bonding, fusion bonding, oxide-to-oxide bonding, hybrid bonding, or the like). The bond pads 42 may be formed of a material similar to those described for the conductive pads 38, such as copper, a copper alloy, or the like, though other materials are possible In some embodiments, a bonding layer (e.g., an exposed dielectric layer) of the electronic die 40 is bonded to a bonding layer (e.g., an exposed dielectric layer, such as the top-most dielectric layer 32) of the interconnect structure 30 using a dielectric-to-dielectric bonding process, and conductive pads of the electronic die 40 are bonded to corresponding conductive pads 38 of the interconnect structure 30 using a metal-to-metal bonding process. In some embodiments, the bonding process may be initiated by activating the bonding surfaces of the electronic die 40 and the interconnect structure 30, which can facilitate bonding of the bonding surfaces. Activating the bonding surfaces may comprise, for example, a dry treatment, a wet treatment, a plasma treatment, exposure to an inert gas plasma, exposure to H₂, exposure to N₂, exposure to O₂, combinations thereof, or the like. For embodiments in which a wet treatment is used, an RCA cleaning process may be used, for example. In other embodiments, the activation process may comprise other types of treatments. After the activation process, the electronic die 40 is aligned and placed into physical contact with the interconnect structure 30. The electronic die 40 and the interconnect structure 30 are then subjected to a thermal treatment and contact pressure to bond respective bonding layers together with dielectric-to-dielectric bonding and bond the conductive pads of the electronic die 40 to the conductive pads 38 of the interconnect structure 30 with metal-to-metal bonding. In some embodiments, the resulting bonded structure is subsequently baked, annealed, pressed, or otherwise treated to strengthen or finalize the bond. This is an example, and other bonding processes are possible. In other embodiments, the electronic die 40 may comprise conductive connectors (e.g. solder bumps, copper bumps, copper pillars, a conductive bump including at least a copper layer and a solder layer, or the like), and may be bonded to the interconnect structure 30 using these conductive connectors.

Further in FIG. 4, a dielectric material 44 is formed over the electronic die 40 and the interconnect structure 30, in accordance with some embodiments. The dielectric material 44 may be formed of silicon oxide, silicon nitride, a polymer, the like, or a combination thereof. The dielectric material 44 may be formed by CVD, PVD, ALD, a spin-on process, the like, or a combination thereof. In some embodiments, the dielectric material 44 may be formed by HDP-CVD, FCVD, PECVD, the like, or a combination thereof. The dielectric material 44 may be a gap-fill material in some embodiments, which may include one or more of the example materials above. In some embodiments, the dielectric material 44 may be a material (e.g., silicon oxide) that is substantially transparent to light at wavelengths suitable for transmitting optical signals or optical power. For example, the dielectric material 44 may allow optical signals or optical power to be transmitted between a photonic component 18 (e.g., a grating coupler 22 or the like) and an overlying optical fiber or the like. The dielectric material 44 may be a material similar to that of the dielectric layers 32 and/or the dielectric layer 16, in some embodiments. Other dielectric materials formed by any acceptable processes may be used. The dielectric material 44 may be planarized using a planarization process such as a CMP process, a grinding process, or the like. In some embodiments, the planarization process may expose the electronic die 40 such that surfaces of the electronic die 40 and the dielectric material 44 are coplanar. In other embodiments, the electronic die 40 is covered by the dielectric material 44.

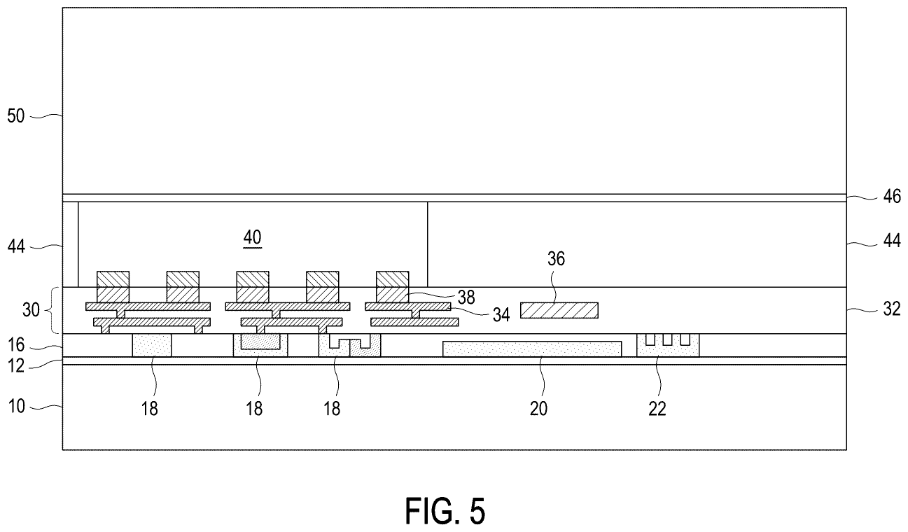

In FIG. 5, a support 50 is attached to the structure, in accordance with some embodiments. The support 50 is a rigid structure or substrate that is attached to the structure in order to provide structural or mechanical stability. The use of a support 50 can reduce warping or bending, which can improve the performance of the photonic components 18 within the optical engine 100. The support 50 may be attached to the structure (e.g., to the dielectric material 44 and/or to the electronic die 40) using a bonding layer 46 formed over the dielectric material 44 and the electronic die 40, in accordance with some embodiments. The bonding layer 46 may be an adhesive layer, in some embodiments. In other embodiments, the bonding layer 46 may be a dielectric layer suitable for dielectric-to-dielectric bonding of the support 50, such as a silicon oxide layer or the like. For example, the bonding layer 46 may be deposited on the dielectric material 44 and the electronic die 40, and then the support 50 may be bonded to the bonding layer 46 using suitable dielectric-to-dielectric bonding techniques. In some embodiments, the support 50 and the bonding layer 46 (if present) are formed of materials transparent to relevant wavelengths of light such that optical signals may be transmitted through the support 50 and the bonding layer 46. For example, in some embodiments, the support 50 is formed of silicon, though other materials are possible. In some embodiments, the support 50 may comprise a carrier or a wafer when attached, such as a silicon wafer or the like. Other types or materials of a support 50 are possible. Subsequently, the support 50 may be sawed or diced into separate regions (e.g., separate substrates) as part of a singulation process that singulates multiple optical engines 100 formed on a same substrate 10 into individual optical engines 100.

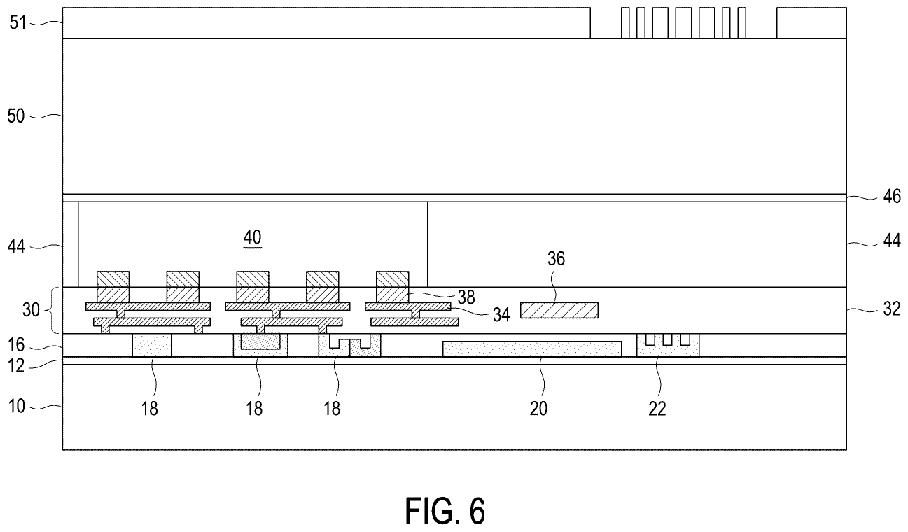

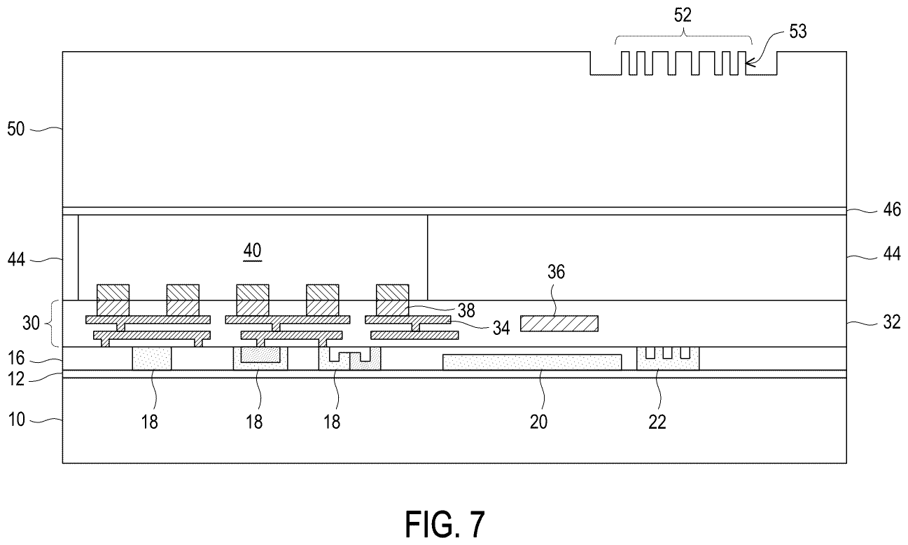

In FIGS. 6 and 7, a metalens 52 is formed in the support 50, in accordance with some embodiments. The metalens 52 is optically coupled to the grating coupler 22 to facilitate external optical communication, described in greater detail below. FIGS. 6-7 illustrate the formation of a single metalens 52 in the support 50, but multiple metalenses 52 may be formed in other embodiments. While the embodiment of FIGS. 1-10 illustrates the metalens 52 being formed just after attachment of the support 50, in other embodiments the metalens 52 may be formed at any suitable process stage after attachment of the support 50. In other embodiments, the metalens 52 is formed in the support 50 prior to attachment of the support 50.

In FIG. 6, a patterned mask 51 is formed over the support 50, in accordance with some embodiments. Forming the patterned mask 51 includes, for example, depositing a mask layer and then patterning the mask layer. The mask layer may be, for example, a photoresist layer, a photoresist structure, a multi-layer photoresist, a hard mask layer, or the like. For example, in some embodiments, the mask layer is a photoresist layer formed using a spin coating technique, though other mask layers or deposition techniques are possible. The mask layer may be patterned using suitable photolithography and/or etching techniques to form the patterned mask 51. The pattern of the patterned mask 51 corresponds to the subsequently-formed metalens 52. The mask layer may then be developed using suitable photolithography and/or etching techniques to form the patterned mask 51. The pattern of the patterned mask may comprise openings or recesses, and may expose portions of the support 50.

In FIG. 7, the support 50 is etched using the patterned mask 51 to form the metalens 52, in accordance with some embodiments. The support 50 may be etched using suitable wet etching processes and/or dry etching processes, some of which may be anisotropic. The etching forms recesses in the top surface of the support 50, with the pattern of the recesses corresponding to the pattern of the patterned mask 51. The recesses define a plurality of “meta-atoms 53,” which are regions or features that protrude from a surface of the support 50. In other words, patterning the support 50 using photolithography and etching steps forms a metalens 52 formed of an arrangement of meta-atoms 53. The metalens 52 may be recessed from the top surface of the support 50, such that the meta-atoms 53 have top surfaces at or below the top surface of the support 50, as shown in FIG. 7. In other embodiments, the surrounding top surface of the support 50 may be etched such that the meta-atoms 53 protrude above the top surface of the support 50. In some embodiments, an index-matching material or the like (not shown) is deposited over the metalens 52. After forming the metalens(es) 52, the patterned mask 51 may be removed using a suitable technique, such as using an etching or ashing process.

The meta-atoms 53 of a metalens 52 may have different sizes, shapes, spacing, or heights. In some cases, the meta-atoms 53 may be considered nanostructures, pillars, protrusions, or the like, and the metalens 52 may be considered a metamaterial (e.g., a photonic metamaterial) or the like. The particular configuration of the meta-atoms 53 of a metalens 52 manipulate electromagnetic fields (e.g., of optical signals) to provide a desired optical effect, such as focusing, beam-steering, optical wavefront shaping, controlling light intensity distribution, or other effects. For example, the meta-atoms 53 of a metalens 52 may be configured to provide a lens-like focusing behavior for incident optical signals. A metalens 52 may have other effects or properties in other embodiments. In some cases, a metalens 52 may be configured for a particular wavelength or range of wavelengths of light, a particular incident (e.g., input) optical wavefront or direction, a particular output optical wavefront or direction, a particular input or output focal length, or various other suitable optical characteristics.

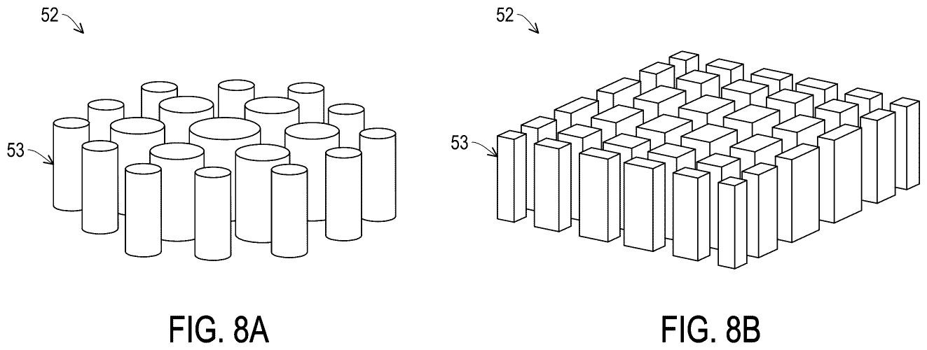

FIGS. 8A and 8B illustrate perspective views of metalenses 52, in accordance with some embodiments. The metalenses 52 shown in FIGS. 8A-8B are intended as non-limiting examples for illustrative purposes, and metalenses 52 having other configurations, arrangements, numbers, or properties of meta-atoms 53 are possible. FIG. 8A illustrates an example metalens 52 comprising a group of circular (e.g., cylindrical) meta-atoms 53 arranged in an approximately hexagonal array pattern. As shown in FIG. 8A, a metalens 52 may include meta-atoms 53 of different sizes, widths, or diameters. In some cases, meta-atoms 53 near the interior (e.g., center) of the meta-lens 52 may have larger sizes than meta-atoms 53 near the exterior (e.g., edge) of the meta-lens 52. FIG. 8B illustrates an example metalens 52 comprising a group of rectangular (e.g., rectangular prism) meta-atoms 53 arranged in an approximately rectangular grid pattern. As shown in FIG. 8B, a metalens 52 may include meta-atoms 53 of different sizes, widths, or lengths. In some cases, a metalens 52 may have meta-atoms 53 of different shapes, such as a combination of circular meta-atoms 53 and rectangular meta-atoms 53, though other combinations of shapes are possible.

The meta-atoms 53 of a metalens 52 may have a symmetrical arrangement or a non-symmetrical arrangement. A meta-atom 53 may have any suitable cross-sectional shape, such as circular, elliptical, square, rectangular, hexagonal, triangular, curved, irregular, or any other shape suitable for the desired properties of the metalens 52. A meta-atom 53 may have a substantially constant cross-section with substantially straight sidewalls, or may have curved or slanted sidewalls. In some cases, a meta-atom 53 may have a tapered shape. Meta-atoms 53 may be arranged in any suitable configuration. For example, meta-atoms 53 may have a regular (e.g., periodic) arrangement, such as being arranged in an array or grid, which may be hexagonal, rectangular, triangular, or any other suitable type. In some cases, meta-atoms 53 may be arranged in an irregular or non-periodic configuration, or in a combination of different configurations. Meta-atoms 53 may have any suitable spacings (e.g., recesses or gaps) between adjacent meta-atoms 53. A metalens 52 may have a different number of meta-atoms 53 than shown. In some embodiments, the meta-atoms 53 of a metalens 52 have about the same height, which may be about the same as the depth of the recesses patterned into the support 50. In some cases, top surfaces of the meta-atoms 53 and the support 50 may be approximately level or coplanar. In other embodiments, different meta-atoms 53 may have different heights or may have top surfaces at different levels. The arrangement or shapes of the meta-atoms 53 may be determined based on the desired properties of the corresponding metalens 52, and any suitable configuration of meta-atoms 53 may be used for metalenses 52.

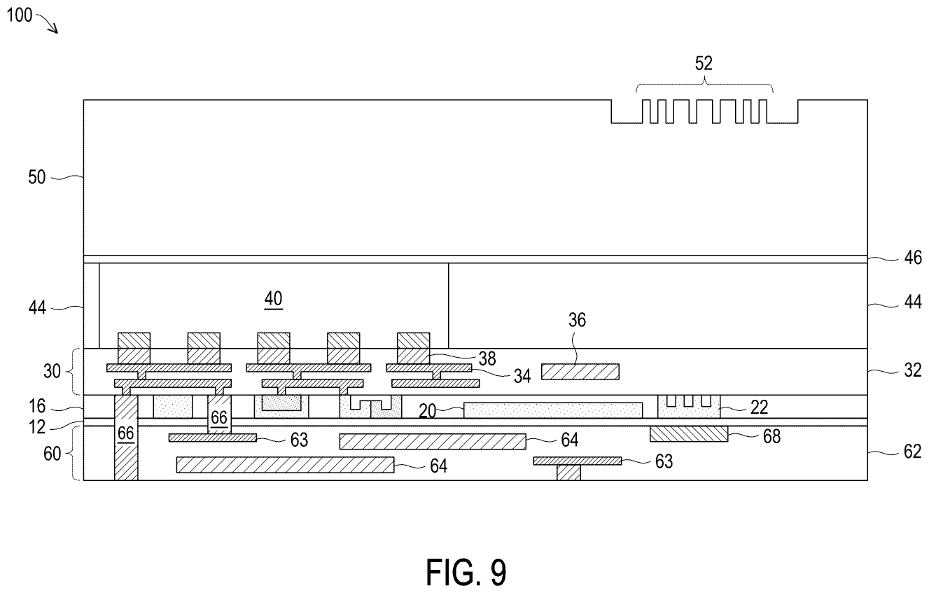

In FIG. 9, the substrate 10 is removed and an interconnect structure 60 is formed, in accordance with some embodiments. The interconnect structure 60 may comprise photonic components such as waveguides 64, reflectors 68, or the like and/or conductive features such as conductive lines 63, conductive vias 66, or the like. The substrate 10 may be removed using a planarization process (e.g., a CMP process, a grinding process, or the like) and/or an etching process. In some embodiments, removing the substrate 10 exposes the dielectric layer 12. Removing the substrate 10 may include thinning of the dielectric layer 12. In some embodiments, the dielectric layer 12 is used as a stop layer during removal of the substrate 10. In other embodiments, the dielectric layer 12 is also removed.

After removing the substrate 10, waveguides 64 are formed over the dielectric layer 12, in accordance with some embodiments. The waveguides 64 may allow for optical communication within the optical engine 100, and some waveguides 64 may be optically coupled to photonic components 18, such as being evanescently coupled to one or more waveguides 20. In this manner, one or more waveguides 64 may receive optical signals from photonic components 18 and/or transmit optical signals to photonic components 18. In some embodiments, the interconnect structure 60 includes one or more layers of waveguides 64 formed within dielectric layers 62 (not individually illustrated). FIG. 9 illustrates two layers of waveguides 64, but more or fewer waveguides 64 or layers of waveguides 64 may be present. In some embodiments, a waveguide 64 may be optically coupled to an adjacent waveguide 64, to an overlying waveguide 64 of another layer, and/or to an underlying waveguide 64 of another layer. Waveguides 64 may be optically coupled using suitable techniques, such as using evanescent coupling, grating couplers, or other optical coupling techniques.

In some embodiments, a layer of waveguides 64 may be formed by depositing a waveguide material on a dielectric layer 62 and then patterning the waveguide material. In some embodiments, the waveguide material may be deposited on the dielectric layer 12 and thus the resulting waveguides 64 are formed on the dielectric layer 12. In other cases, the waveguide material is deposited on an existing dielectric layer 62. The waveguide material may be a dielectric material such as silicon nitride, silicon oxide, silicon oxynitride, polymer, combinations of these, or the like. In other embodiments, the waveguide material may be a semiconductor material such as silicon, germanium, or the like. The waveguide material may be deposited using a suitable technique, such as ALD, PVD, or the like. The waveguide material may then be patterned using suitable photolithography and etching techniques to form a layer of waveguides 64. A dielectric layer 62 may then be deposited over the layer of the waveguides 64. The dielectric layers 52 may be a material similar to the dielectric layer 16 or the dielectric layers 32, such as silicon oxide or the like. The steps of depositing a waveguide material, patterning the waveguide material to form a layer of waveguides 64, and then depositing a dielectric layer 62 over the layer of waveguides 64 may be repeated to form multiple layers of waveguides 64. The precise number or arrangement of layers of waveguides 64 may be dependent upon the design of the optical engine 100.

The conductive features 63 of the interconnect structure 60 may comprise conductive lines, conductive vias, conductive pads, metallization patterns, redistribution layers, or the like that provide electrical interconnections and electrical routing within the optical engine 100. Some conductive features 63 may be electrically connected to one or more photonic components, in some cases. In some embodiments, the interconnect structure 60 includes one or more layers of conductive features 63 formed in one or more dielectric layers 62. In this manner, the interconnect structure 60 may include both waveguides 64 and conductive features 63 formed in the dielectric layers 62. In some embodiments, the conductive features 63 may be similar to the conductive features 34 of the interconnect structure 30, and may be formed using similar materials and/or techniques. For example, the conductive features 63 may be formed using any suitable processes such as deposition, damascene, dual damascene, or the like. The precise number or arrangement of layers of conductive features 63 may be dependent upon the design of the optical engine 100.

In some embodiments, the interconnect structure 60 includes one or more reflectors 68, which may be formed underneath corresponding grating couplers 22. The reflectors 68 may be metallic structures that facilitate transmission of optical signals to or from the grating couplers 22. In some embodiments, the reflectors 68 may be formed along with some conductive features 63, and are formed using the same materials and process steps as some conductive features 63. In other embodiments, the reflectors 68 are formed using different materials or process steps than the conductive features 63.

In some embodiments, the interconnect structure 60 includes vias 66. The vias 66 may extend through one or more dielectric layers 62, and may extend through other layers to make electrical connections within the optical engine 100. For example, a via 66 may extend from a conductive feature 63 of the interconnect structure 60 to a conductive feature 34 of the interconnect structure 30. In this manner, a via 66 may extend through a dielectric layer 62, the dielectric layer 12, the dielectric layer 16, and/or a dielectric layer 32, in some cases. A via 66 may be electrically connected to a photonic component, in some cases. The vias 66 may be formed, for example, by forming openings extending through appropriate dielectric layer(s) using acceptable photolithography and etching techniques. Conductive material may then be deposited in the openings, thereby forming the vias 66. Vias 66 may extend fully through the interconnect structure 60, or may extend partially through the interconnect structure 60. Vias 66 may be formed during formation of the interconnect structure 60 or may be formed after formation of the interconnect structure 60. Other materials or techniques are possible.

In FIG. 10, conductive connectors 74 are formed on the interconnect structure 60 to form an optical engine 100, in accordance with some embodiments. The conductive connectors 74 may be used to electrically connect the optical engine 100 to an external structure such as a package substrate, an organic core substrate, an interposer, or the like. In some embodiments, an optional passivation layer 70 is formed over the interconnect structure 70. The passivation layer 70 may comprise, for example, a polymer such as polybenzoxazole (PBO), polyimide, a benzocyclobuten (BCB) based polymer, or the like; a nitride such as silicon nitride or the like; an oxide such as silicon oxide, PSG, BSG, BPSG, or the like; an encapsulant, molding compound, or the like; the like, or a combination thereof. The passivation layer 70 may be formed, for example, by spin coating, lamination, CVD, PVD, ALD, or the like. In some cases, the passivation layer 70 may be a dielectric layer 62 or otherwise may be considered part of the interconnect structure 60.

Under-bump metallizations (UBMs) 72 may then be formed within the passivation layer 70 to make physical and electrical contact to vias 66 and/or conductive features 63. In other embodiments, the UBMs 72 are formed prior to forming the passivation layer 70. In some embodiments, the UBMs 72 have bump portions on and extending along the major surface of the passivation layer 70. The UBMs 72 may be formed of one or more conductive materials using a suitable process, such as plating. In some embodiments, the UBMs 72 are not formed.

The conductive connectors 74 are then formed on the UBMs 72, in accordance with some embodiments. The conductive connectors 74 may be, for example, ball grid array (BGA) connectors, solder balls, metal pillars, controlled collapse chip connection (C4) bumps, micro bumps, electroless nickel-electroless palladium-immersion gold technique (ENEPIG) formed bumps, or the like. The conductive connectors 74 may include a conductive material such as solder, copper, aluminum, gold, nickel, silver, palladium, tin, the like, or a combination thereof. In some embodiments, the conductive connectors 74 are formed by initially forming a layer of solder through evaporation, electroplating, printing, solder transfer, ball placement, or the like. Once a layer of solder has been formed on the structure, a reflow may be performed in order to shape the material into the desired bump shapes. In another embodiment, the conductive connectors 74 comprise metal pillars (such as a copper pillar) formed by a sputtering, printing, electro plating, electroless plating, CVD, or the like. The metal pillars may be solder free and have substantially vertical sidewalls. In some embodiments, a metal cap layer is formed on the top of the metal pillars. The metal cap layer may include nickel, tin, tin-lead, gold, silver, palladium, indium, nickel-palladium-gold, nickel-gold, the like, or a combination thereof and may be formed by a plating process. In other embodiments, the conductive connectors 74 are omitted and the UBMs 72 are bonding pads used for metal-to-metal bonding to an external component. In this manner, an optical engine 100 may be formed. The optical engine 100 shown in FIG. 10 is an example, and other process steps, materials, configurations, or arrangements are possible.

The metalens 52 of the optical engine 100 as described herein can facilitate transmission of optical signals 110 (represented as arrows in the figures) to an external component such as an optical fiber 150 or the like, in accordance with some embodiments. The optical fiber 150 may be a single optical fiber or may be part of a fiber bundle, a fiber array unit (FAU), or the like. In some cases, the optical fiber 150 may be attached to the support 50 by an optical glue or the like (not illustrated). As an example, the optical engine 100 may generate or otherwise transmit optical signals 110 in a waveguide 20 that is optically coupled to a grating coupler 22. The optical signals 110 may be coupled into the grating coupler 22, which directs the optical signals 110 through the support 50 to the metalens 52. In some embodiments, a reflector 68 facilitates redirection of the optical signals 110 toward the metalens 52. The metalens 52 may partially or fully overlap its corresponding grating coupler 22, or may not overlap its corresponding grating coupler 22. The metalens 52 may be aligned with or laterally offset from the grating coupler 22. In other words, the optical signals 110 may be transmitted vertically or obliquely (e.g., at a nonzero angle from the vertical) from a grating coupler 22 to its corresponding metalens 52. The metalens 52 receives the optical signals 110 from the grating coupler 22 and focuses the optical signals 110, represented in FIG. 10 by a focused signal 110′. The metalens 52 directs the focused signal 110′ toward the fiber 150 such that the focused signal 110′ couples into the optical fiber 150. For example, the focal point of the focused signal 110′ may be at or near the end of the optical fiber 150, in some cases. The focused signal 110′ may be transmitted vertically or obliquely (e.g., at a nonzero angle from the vertical) from a metalens 52 to an optical fiber 150. In this manner, the metalens 52 couples optical signals 110 from the optical engine 100 into an optical fiber 150, allowing for external optical communication.

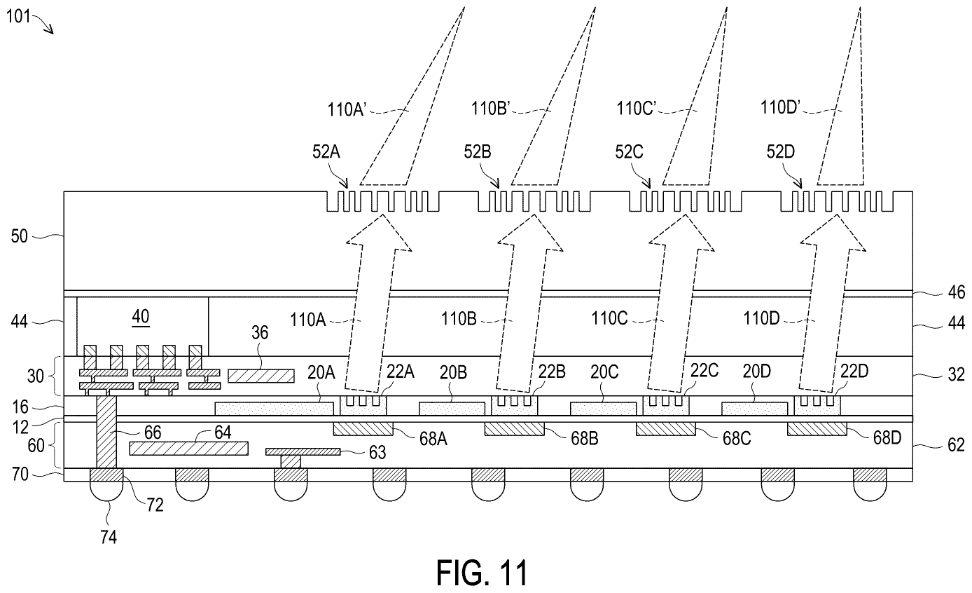

FIG. 11 illustrates an optical engine 101 comprising multiple metalenses 52A-D, in accordance with some embodiments. The optical engine 101 is similar to the optical engine 100 of FIG. 10, except that the optical engine 101 comprises multiple metalenses 52A-D and multiple grating couplers 22A-D. Each metalens 52A-D is optically coupled to a corresponding grating coupler 22A-D. For example, the metalenses 52A, 52B, 52C, and 52D are configured to receive optical signals from corresponding grating couplers 22A, 22B, 22C, and 22D, respectively. Four metalenses 52A-D with four corresponding grating couplers 22A-D are shown in FIG. 11, but an optical engine 101 may have any suitable number of metalenses 52 and grating couplers 22. The metalenses 52A-D may be formed using techniques similar to that described for the metalens 52 of the optical engine 100, such as photolithography and etching techniques. The metalenses 52A-D may be separated by protruding portions of the support 50, as shown in FIG. 11, or may be separated by recessed portions of the support 50. In other words, surfaces of the support 50 between neighboring metalenses 52 may be level with or below top surfaces of the meta-atoms 53 of the metalenses 52.

In some embodiments, each grating coupler 22A-D may receive respective optical signals 110A-D from respective waveguides 20A-D and direct the optical signals 110A-D to their respectively associated metalens 52A-D. Each metalens 52A-D focuses the received optical signals 110A-D, shown as focused signals 110′A-D. In this manner, multiple optical signals 110 may be transmitted outside of the optical engine 101 using multiple metalenses 52. The multiple metalenses 52A-D may focus their corresponding focused signals 110′A-D at the same location (e.g., into the same optical fiber 150) or at different locations (e.g., into different optical fibers 150).

In some embodiments, optical signals may be transmitted using different wavelengths of light, for example, so that a single waveguide or optical fiber may simultaneously carry multiple optical signals of different wavelengths. The use of metalenses 52 as described herein can facilitate the transmission of multiple optical signals of multiple wavelengths (e.g., wavelength division multiplexing). One of ordinary skill in the art would understand that while an optical signal may be described as having an associated wavelength, an optical signal may comprise a range of wavelengths around a central wavelength, a carrier wavelength, or the like. In some embodiments, each of the optical signals 110A-D may be transmitted using a different wavelength of light (e.g., or a range of wavelengths), with associated grating couplers 22A-D and metalenses 52A-D configured to transmit and focus light of a particular wavelength (e.g., or a range of wavelengths). Accordingly, each optical signal 110A-D may be transmitted along a different path. As an example of “Course Wavelength Division Multiplexing,” the optical signals 110A-D may have wavelengths separated by about 10 nm to about 25 nm, such as the optical signal 110A being at a wavelength of about 1310 nm, the optical signal 110B being at about 1330 nm, the optical signal 110C being at about 1350 nm, and the optical signal 110D being at about 1370 nm. Other wavelength differences are possible, such as the optical signals 110A-D being separated by about 1 nm to about 10 nm for “Long Wavelength Division Multiplexing,” or the optical signals 110A-D being separated by about 0.5 nm to about 1 nm for “Dense Wavelength Division Multiplexing.” These examples are intended as illustrative, and any suitable different wavelengths or differences in wavelengths may be utilized. More or fewer wavelengths and corresponding optical signal paths may be utilized in an optical engine 101, and the number of wavelengths and/or optical signal paths may depend on the amount of data transmission desired. In this manner, each metalens 52A-D may be configured to focus a different wavelength of light. In other embodiments, two or more of the optical signals 110A-D may be transmitted using the same wavelength of light.

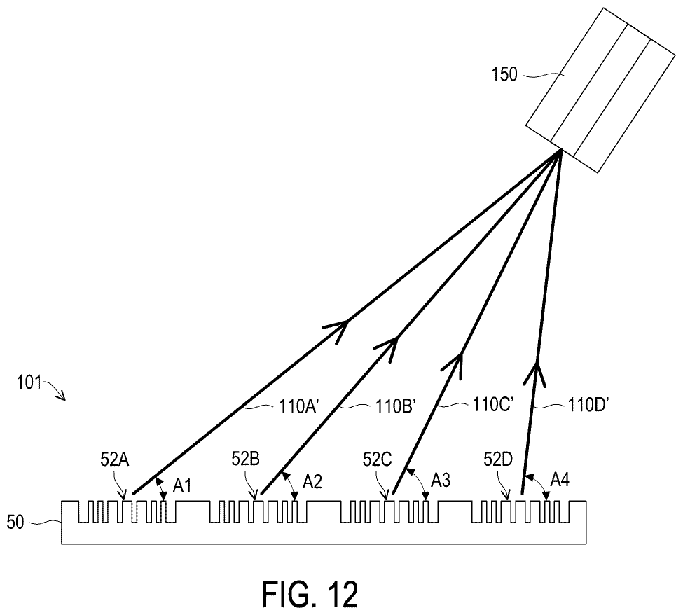

FIG. 12 illustrates a schematic view of metalenses 52A-D configured to transmit focused signals 110′A-D into an optical fiber 150, in accordance with some embodiments. The metalenses 52A-D may be formed in a support 50, which may be part of an optical engine similar to the optical engine 101 of FIG. 11. Each of the focused signals 110′A-D may use a different wavelength of light, in some cases. As shown in FIG. 12, each metalens 52A-D directs its focused signal 110′A-D into the same optical fiber 150, and thus each metalens 52A-D has approximately the same focal point (e.g., the metalenses 52A-D are confocal). Each metalens 52A-D may be a different distance from the optical fiber 150, and accordingly, the focal length of each metalens 52A-D may be different. Additionally, each metalens 52A-D may direct its focused signal 110′A-D at a different angle toward the optical fiber 150. For example, the focused signals 110′A-D shown in FIG. 12 are respectively directed at angles A1-A4 to a horizontal plane. The angle of a focused signal 110′A-D may be between about 0° and about 90°. In this manner, multiple metalenses 52 may couple multiple optical signals of different wavelengths into the same optical fiber 150.

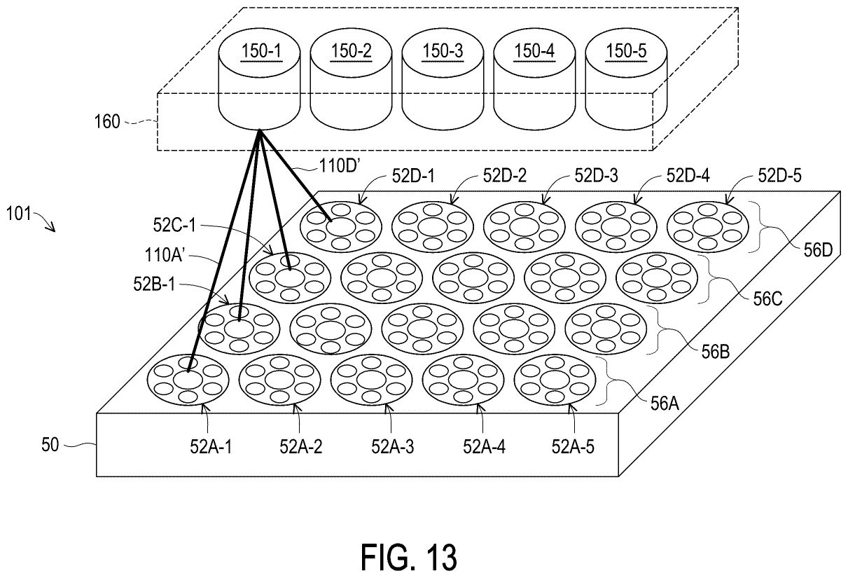

FIG. 13 illustrates a perspective-view schematic of metalenses 52 configured to transmit focused signals 110′ into a fiber array 160, in accordance with some embodiments. Some example focused signals 110′ are illustrated. The metalenses 52 may be formed in a support 50, which may be part of an optical engine similar to the optical engine 101 of FIG. 11. The fiber array 160 may be, for example, a FAU or the like comprising a plurality of optical fibers 150. In some cases, the fiber array 160 is attached to the optical engine 101, and an optical glue or an index-matching compound (not shown) may be used to facilitate attachment and/or the transmission of optical signals between the optical engine 101 and the fiber array 160. The fiber array 160 is shown as having five optical fibers 150-1, 150-2, 150-3, 150-4, and 150-5, but other numbers or arrangements of optical fibers are possible. The metalenses 52 are shown as being formed in a grid-like arrangement, but other numbers or arrangements of metalenses 52 are possible.

In the embodiment shown in FIG. 13, the metalenses 52 in each row 56 of metalenses 52 are configured to transmit optical signals of a similar wavelength of light. For example, the metalenses 52A-1, 52A-2, 52A-3, 52A-4, and 52A-5 in row 56A are configured to transmit optical signals of a first wavelength of light, and the metalenses 52D-1, 52D-2, 52D-3, 52D-4, and 52D-5 in row 56D are configured to transmit optical signals of a second wavelength of light. In the embodiment of FIG. 13, the metalenses 52 in each column each are configured to transmit optical signals of different wavelengths. For example, the metalenses 52A-1, 52B-1, 52C-1, and 52D-1 each may transmit optical signals of a different wavelength. Further, the metalenses 52 in each column are associated with a particular optical fiber 150 and direct focused signals 110′ into that optical fiber 150. For example, the metalenses 52A-1, 52B-1, 52C-1, and 52D-1 direct respective focused signals 110′A, 110′B, 110′C, and 110′D into the optical fiber 150-1, with each focused signal 110′A-D having a different wavelength. Each optical fiber 150 may be located at a similar position relative to its corresponding column of metalenses 52. Each metalens 52 in a row 56 may be configured for the same wavelength, angle, and focal length in order to couple their focused signal 110′ into their corresponding optical fiber 150. Accordingly, the design or structure of each metalens 52 in a row 56 may be similar, and the design or structure of each metalens 52 in a column may be different. In this manner, an optical engine 101 may utilize a plurality of metalenses 52 to transmit optical signals of different wavelengths into a plurality of optical fibers 150. The arrangement and association of metalenses 52, focused signals 110′, and optical fibers 150 is an example, and other arrangements or configurations are possible.

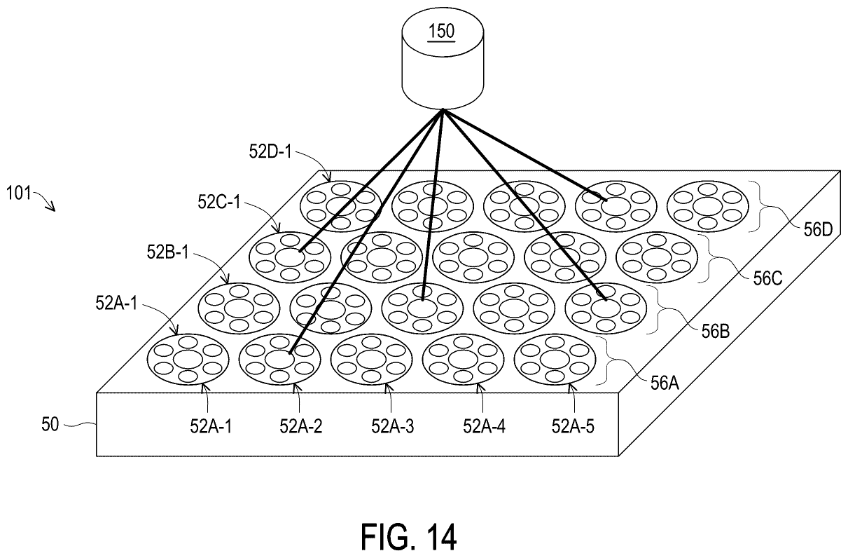

FIG. 14 illustrates a perspective-view schematic of metalenses 52 configured to transmit focused signals 110′ into a single optical fiber 150, in accordance with some embodiments. Some example focused signals 110′ are shown. The structure shown in FIG. 14 is similar to that shown in FIG. 13, except that the metalenses 52 in the structure of FIG. 14 are all configured to direct focused signals 110′ into the same optical fiber 150. Accordingly, the design or structure of each metalens 52 may be different. In some cases, the optical fiber 150 is attached to the optical engine 101, and an optical glue or an index-matching compound (not shown) may be used to facilitate attachment and/or the transmission of optical signals between the optical engine 101 and the optical fiber 150. In some embodiments, the metalenses 52 in each row 56 may be configured to transmit optical signals of the same wavelength, and the metalenses 52 in each column may be configured to transmit optical signals of different wavelengths. In this manner, an optical engine 101 may utilize a plurality of metalenses 52 to transmit optical signals of different wavelengths into a single optical fiber 150. The arrangement of metalenses 52, focused signals 110′, and optical fiber 150 is an example, and other arrangements or configurations are possible.

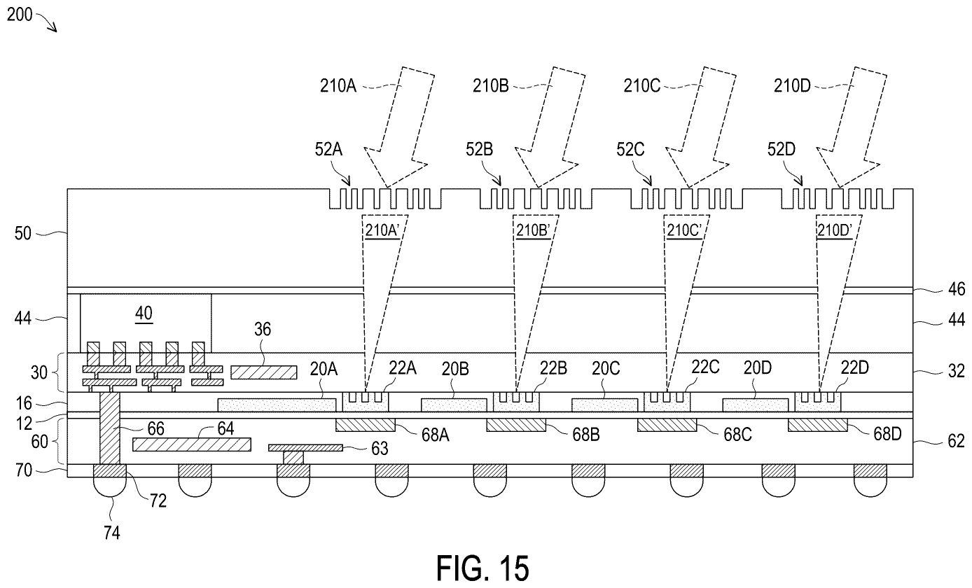

FIG. 15 illustrates an optical engine 200, in accordance with some embodiments. The optical engine 200 is similar to the optical engine 101, except that the optical engine 200 is configured to receive optical signals 210 from an optical fiber, fiber array, FAU, photonic component, or the like (not illustrated). For example, the metalenses 52A-D may receive optical signals 210A-D from an optical fiber or the like, and focus the optical signals (shown as focused signals 210′A-D) into corresponding grating couplers 22A-D. The optical signals may then be coupled into one or more waveguides 20A-D. In some embodiments, an optical engine 200 may both transmit (e.g., output) and receive optical signals. In some cases, a metalens 52 and/or a grating coupler 22 may be used for both transmitting and receiving optical signals. Other arrangements or configurations are possible.

Embodiments of the present disclosure have some advantageous features. The use of metalenses as described herein can allow for increased freedom in the control or manipulation of optical signals. For example, the use of a metalens in an optical engine may allow for increased design flexibility for optical control characteristics such as focal length, focal direction, transmission angle, wavelength, intensity distribution, or the like. In some embodiments, metalenses with different design parameters (e.g., different meta-atom shapes, sizes, distribution, spacing, etc.) can allow for the guiding of light beams from different grating couplers to a single optical fiber or to an array of optical fibers. The metalenses can facilitate efficient wavelength division multiplexing and can improve optical communication between photonic components or photonic packages. The use of metalenses as described herein can allow for increased design flexibility, smaller package size, improved bandwidth, and improved device performance. By forming metalenses in the support structure of an optical engine, design flexibility can be improved and manufacturing cost can be reduced.

In an embodiment of the present disclosure, a device includes a photonic layer that includes a waveguide and a grating coupler, wherein the waveguide is optically coupled to the grating coupler; an interconnect structure over the photonic layer; an electronic die bonded to the interconnect structure; and a support over the electronic die, wherein the support includes a metalens, wherein the metalens is optically coupled to the grating coupler. In an embodiment, the device includes an optical fiber over the support, wherein the optical fiber is optically coupled to the metalens. In an embodiment, the metalens has a focal point at the optical fiber. In an embodiment, the metalens includes meta-atoms having cylindrical shapes. In an embodiment, the support includes a silicon substrate. In an embodiment, the metalens includes meta-atoms that are separated by recesses in a top surface of the support. In an embodiment, the metalens includes meta-atoms that protrude from a top surface of the support. In an embodiment, the metalens at least partially overlaps the grating coupler.

In an embodiment of the present disclosure, a package includes a photonic interconnect structure that includes waveguides, a first grating coupler, and a second grating coupler, wherein the first grating coupler is configured for a first wavelength, wherein the second grating coupler is configured for a second wavelength; an electronic die attached to the photonic interconnect structure; and a support over the electronic die, wherein the support includes a first metalens and a second metalens, wherein the first metalens is optically coupled to the first grating coupler and configured for the first wavelength, wherein the second metalens is optically coupled to the second grating coupler and configured for the second wavelength. In an embodiment, the first metalens and the second metalens are configured to focus optical signals into a first optical fiber over the support. In an embodiment, the first optical fiber is part of a fiber array. In an embodiment, the package includes a third grating coupler and a third metalens, wherein the third grating coupler and the third metalens are configured for the first wavelength. In an embodiment, the first metalens has a first focal length above the support and the second metalens has a second focal length above the support. In an embodiment, the first wavelength and the second wavelength are separated less than 25 nm. In an embodiment, the first metalens is configured to focus optical signals at first angle above the support and the second metalens is configured to focus optical signals at second angle above the support. In an embodiment, the first metalens is configured to focus optical signals into a first optical fiber over the support and the second metalens is configured to focus optical signals into a second optical fiber over the support.

In an embodiment of the present disclosure, a method includes patterning a photonic material to form photonic components including a waveguide and a grating coupler; forming a first interconnect structure over a first side of the photonic components, wherein the first interconnect structure is electrically coupled to at least one photonic component; bonding an electronic die to the first interconnect structure; attaching a support structure to the electronic die; and patterning a top surface of the support structure to form a metalens, wherein the metalens is optically coupled to the grating coupler through the support structure. In an embodiment, the support structure is attached to the electronic die before forming the metalens. In an embodiment, the method includes attaching an optical fiber to the support structure, wherein the optical fiber is optically coupled to the metalens. In an embodiment, the method includes forming a second interconnect structure over a second side of the photonic components.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device comprising:
a photonic layer comprising a waveguide and a grating coupler, wherein the waveguide is optically coupled to the grating coupler;
an interconnect structure over the photonic layer;
an electronic die bonded to the interconnect structure; and
a support over the electronic die, wherein the support comprises a metalens, wherein the metalens is optically coupled to the grating coupler.

2. The device of claim 1 further comprising an optical fiber over the support, wherein the optical fiber is optically coupled to the metalens.

3. The device of claim 2, wherein the metalens has a focal point at the optical fiber.

4. The device of claim 1, wherein the metalens comprises meta-atoms having cylindrical shapes.

5. The device of claim 1, wherein the support comprises a silicon substrate.

6. The device of claim 1, wherein the metalens comprises meta-atoms that are separated by recesses in a top surface of the support.

7. The device of claim 1, wherein the metalens comprises meta-atoms that protrude from a top surface of the support.

8. The device of claim 1, wherein the metalens at least partially overlaps the grating coupler.

9. A package comprising:
a photonic interconnect structure comprising a plurality of waveguides, a first grating coupler, and a second grating coupler, wherein the first grating coupler is configured for a first wavelength, wherein the second grating coupler is configured for a second wavelength;
an electronic die attached to the photonic interconnect structure; and
a support over the electronic die, wherein the support comprises a first metalens and a second metalens, wherein the first metalens is optically coupled to the first grating coupler and configured for the first wavelength, wherein the second metalens is optically coupled to the second grating coupler and configured for the second wavelength.

10. The package of claim 9, wherein the first metalens and the second metalens are configured to focus optical signals into a first optical fiber over the support.

11. The package of claim 10, wherein the first optical fiber is part of a fiber array.

12. The package of claim 9 further comprising a third grating coupler and a third metalens, wherein the third grating coupler and the third metalens are configured for the first wavelength.

13. The package of claim 9, wherein the first metalens has a first focal length above the support and the second metalens has a second focal length above the support.

14. The package of claim 9, wherein the first wavelength and the second wavelength are separated less than 25 nm.

15. The package of claim 9, wherein the first metalens is configured to focus optical signals at first angle above the support and the second metalens is configured to focus optical signals at second angle above the support.

16. The package of claim 9, wherein the first metalens is configured to focus optical signals into a first optical fiber over the support and the second metalens is configured to focus optical signals into a second optical fiber over the support.

17. A method comprising:
patterning a photonic material to form a plurality of photonic components comprising a waveguide and a grating coupler;
forming a first interconnect structure over a first side of the plurality of photonic components, wherein the first interconnect structure is electrically coupled to at least one photonic component of the plurality of photonic components;
bonding an electronic die to the first interconnect structure;
attaching a support structure to the electronic die; and
patterning a top surface of the support structure to form a metalens, wherein the metalens is optically coupled to the grating coupler through the support structure.

18. The method of claim 17, wherein the support structure is attached to the electronic die before forming the metalens.

19. The method of claim 17 further comprising attaching an optical fiber to the support structure, wherein the optical fiber is optically coupled to the metalens.

20. The method of claim 17 further comprising forming a second interconnect structure over a second side of the plurality of photonic components.
